(19) United States
(12) Patent Application Publication
(10) Pub. No.: US 2026/0088538 A1
(43) Pub. Date: Mar. 26, 2026

(54) CONNECTOR ASSEMBLY

(71) Applicant: Lear Corporation, Southfield, MI (US)

(72) Inventors: Edgar Michael T. Racho, Lapu-Lapu City (PH); Albert M. Cabañero, Cebu City (PH)

(21) Appl. No.: 18/895,922

(22) Filed: Sep. 25, 2024

(51) Int. Cl. H01R 12/77; H01R 43/20

(52) U.S. Cl. CPC H01R 12/774; H01R 43/20

(57) ABSTRACT

A connector assembly includes a housing, a first locking member, and a second locking member. The housing may include a first end adapted to receive said substantially planar cable and may include a second end adapted to receive said one or more terminals. The first locking member may be connected to the housing, and the first locking member ay be movable from a pre-loaded position to a closed position configured to secure said substantially planar cable. The second locking member may be connectable to the housing in a direction substantially perpendicular to said substantially planar cable. In a connected position, the second locking member may electrically connect said one or more terminals with said substantially planar cable.

### TECHNICAL FIELD

The present disclosure generally relates to connector assemblies, including connector assemblies that may include one or more locking members that may, for example, be used in electrically coupling at least one terminal with a substantially planar cable.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view generally illustrating an embodiment of a connector assembly according to teachings of the present disclosure.

FIG. 2 is a top view generally illustrating an embodiment of a connector assembly according to teachings of the present disclosure.

FIG. 3A is a side view generally illustrating an embodiment of a connector assembly according to teachings of the present disclosure.

FIG. 3B is a side view generally illustrating an embodiment of a connector assembly according to teachings of the present disclosure.

FIG. 4 is a perspective view generally illustrating an embodiment of a terminal to be received by the connector assembly according to teachings of the present disclosure.

FIG. 5A is a top view generally illustrating an embodiment of a terminal to be received by the connector assembly according to teachings of the present disclosure.

FIG. 5B is a side view generally illustrating an embodiment of a terminal to be received by the connector assembly according to teachings of the present disclosure.

FIG. 5C is a side view generally illustrating an embodiment of a terminal to be receive by the connector assembly according to teachings of the present disclosure.

FIG. 6A is a perspective view generally illustrating an embodiment of a connector assembly including a first locking member and a second locking member disposed in a pre-loaded position according to teachings of the present disclosure.

FIG. 6B is a perspective view generally illustrating an embodiment of a connector assembly including a first locking member and a second locking member disposed in a closed position according to teachings of the present disclosure.

FIG. 7A is a side sectional view generally illustrating an embodiment of a connector assembly having a second locking member in a pre-loaded state according to teachings of the present disclosure.

FIG. 7B is a side sectional view generally illustrating an embodiment of a connector assembly having a second locking member in a closed position according to teachings of the present disclosure.

FIG. 8A is a side sectional view generally illustrating an embodiment of a connector assembly having a first locking member and a second locking member disposed in a closed position according to teachings of the present disclosure.

FIG. 8B is a side sectional view generally illustrating an embodiment of a connector assembly having a first locking member and a second locking member disposed in a closed position according to teachings of the present disclosure.

FIG. 9 is an exploded perspective view generally illustrating an embodiment of the connector assembly according to teachings of the present disclosure.

FIG. 10A is a perspective view generally illustrating an embodiment of the connector assembly having a first locking member and a second locking member disposed in the pre-loaded position according to teachings of the present disclosure.

FIG. 10B is a perspective view generally illustrating an embodiment of the connector assembly having a first locking member and a second locking member disposed in the closed position according to teachings of the present disclosure.

FIG. 11A is a top view generally illustrating an embodiment of a connector assembly according to teachings of the present disclosure.

FIG. 11B is a side view generally illustrating an embodiment of a connector assembly according to teachings of the present disclosure.

FIG. 11C is a side view generally illustrating an embodiment of a connector assembly according to teachings of the present disclosure.

FIG. 12 is a perspective view generally illustrating an embodiment of a connector assembly having a first housing portion and a second housing portion according to teachings of the present disclosure.

FIG. 13A is a top view generally illustrating an embodiment of a second housing portion according to teachings of the present disclosure.

FIG. 13B is a side view generally illustrating an embodiment of a second housing portion according to teachings of the present disclosure.

FIG. 13C is a side view generally illustrating an embodiment of a second housing portion according to teachings of the present disclosure.

FIG. 14A is a perspective view generally illustrating an embodiment of a terminal according to teachings of the present disclosure.

FIG. 14B is a top view generally illustrating an embodiment of a terminal according to teachings of the present disclosure.

FIG. 15A is a side view generally illustrating an embodiment of a terminal according to teachings of the present disclosure.

FIG. 15B is a side view generally illustrating an embodiment of a terminal according to teachings of the present disclosure.

FIG. 16A is a side view generally illustrating an embodiment of a terminal according to teachings of the present disclosure.

FIG. 16B is a top view generally illustrating an embodiment of a terminal according to teachings of the present disclosure.

FIGS. 17A and 17B are side views generally illustrating an embodiment of a terminal according to teachings of the present disclosure.

FIGS. 18A, 18B, and 18C are perspective views generally illustrating an embodiment of a connector assembly with locking members moving from a pre-loaded position to a closed position according to teachings of the present disclosure.

FIGS. 19A and 19B are perspective views generally illustrating an embodiment of a connector assembly having a first housing portion, a second housing portion, and a third housing portion.

FIG. 20 is a side-sectional view generally illustrating an embodiment of a connector assembly having a first locking member and a second locking member in the closed position according to teachings of the present disclosure.

FIG. 21 is a perspective view generally illustrating an embodiment of a connector assembly having a first housing portion connected with a printed circuit board according to teachings of the present disclosure.

FIG. 22 is a perspective view generally illustrating an embodiment of a connector assembly having a sleeve connected with the second housing portion according to teachings of the present disclosure.

FIG. 23 is a perspective view generally illustrating an embodiment of a connector assembly having a switch assembly connected with the second housing portion according to teachings of the present disclosure.

FIG. 24 is a flowchart generally illustrating a method of assembling a connector assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

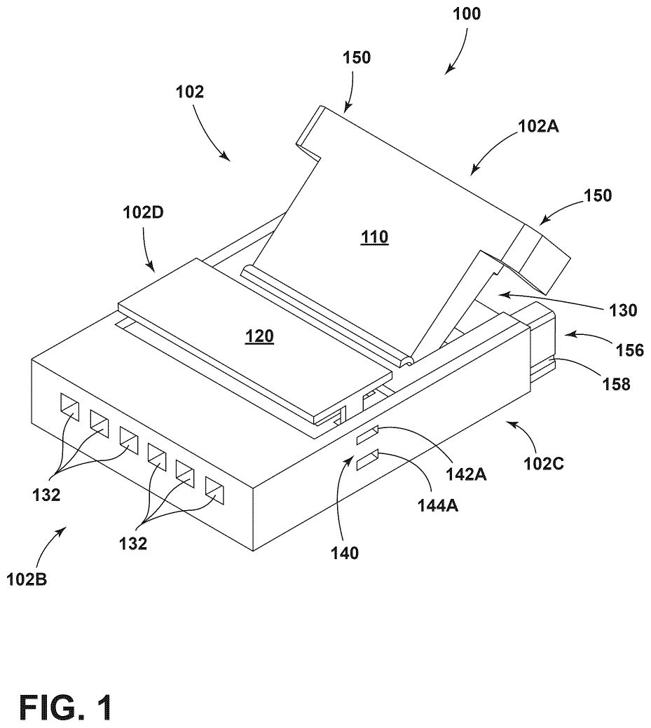

In embodiments, such as generally illustrated in FIG. 1, a connector assembly 100 may connect a round stranded wire with a flat flexible cable in one or more of a variety of manners. The connector assembly 100 may include a housing 102 further configured to at least partially receive a substantially planar cable 104 and/or one or more terminals 106. The housing 102 may electrically connect the one or more terminals 106 with the substantially planar cable 104. The housing 102 may include a shape such as to facilitate connection between the substantially planar cable 104 and one or more terminals 106 (e.g., a round stranded wire 108). Further, the housing 102 may include one or more of a variety of shapes, sizes, and/or configurations. For example and without limitation, the housing 102 may be substantially rectangular shaped and/or may comprise any variety of plastic material (e.g., a variety of polymer).

In examples, the housing 102 may include a first side 102A, a second side 102B, a third side 102C, and a fourth side 102D. The first side 102A may be disposed opposite to the second side 102B; the third side 102C may be disposed opposite to the fourth side 102D, and the third side 102C may be adjacent to the first side 102A and the second side 102B. A first locking member 110 may be disposed substantially proximate the first side 102A to connect the substantially planar cable 104 with the housing 102; and on the opposite end, the second side 102B, a second locking member 120 may be disposed to connect the one or more terminals 106 (e.g., one or more round stranded wires 108) with the housing 102.

Generally, the housing 102 may electrically connect the one or more terminals 106 (e.g., connected with one or more round stranded wires 108) with the substantially planar cable 104. For example and without limitation, a first locking member 110 may substantially limit movement of the substantially planar cable 104; and, in a similar nature, a second locking member 120 may substantially limit movement of the one or more terminals 106 to facilitate an electrical connection between the substantially planar cable 104 and the one or more terminals 106. The first locking member 110 may be configured for rotational locking, and/or the second locking member 120 may be configured for linear locking.

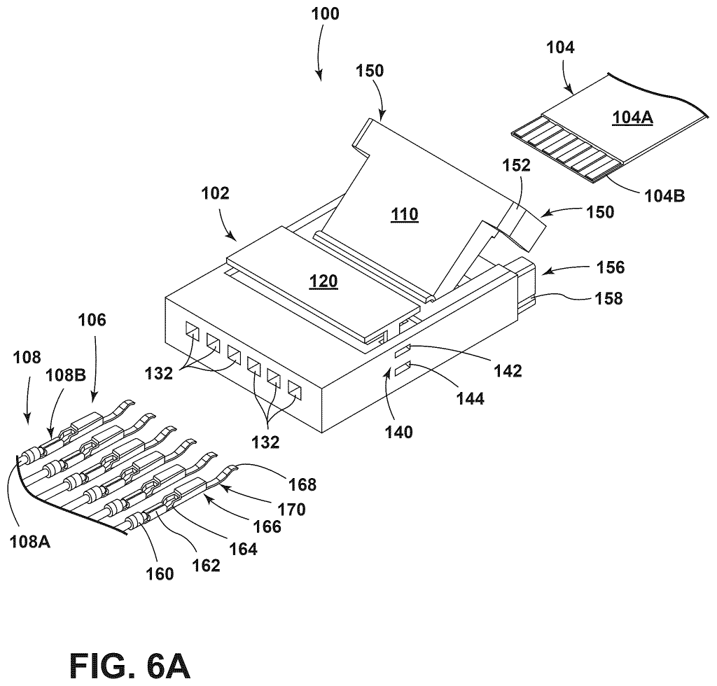

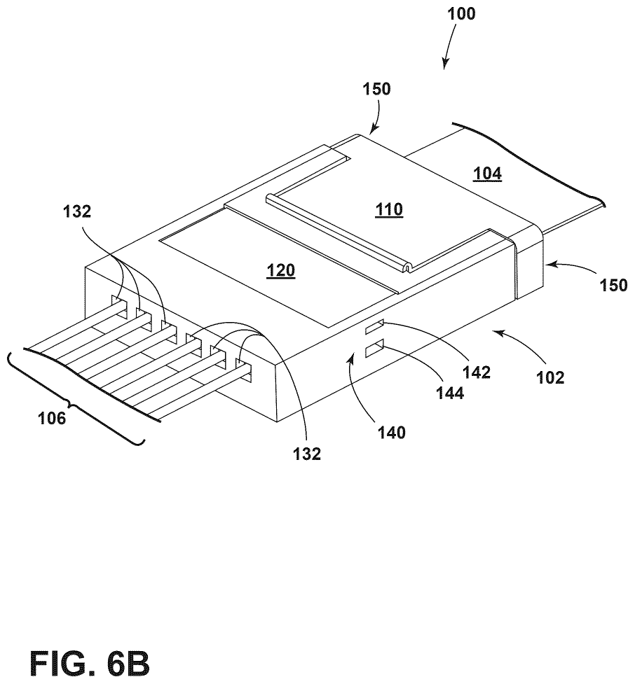

With embodiments, as illustrated in FIGS. 1-3B, the first locking member 110 may transition/move between a pre-loaded position and a closed position to secure the substantially planar cable 104 with the housing 102 (e.g., the one or more terminals 106). Movement of the first locking member 110 may include one or more of a variety of locking motions, such as rotational locking. As can be seen later in FIGS. 6A and 6B, the first locking member 110 may rotate when moving between the pre-loaded position and the closed position. Generally, rotation of the first locking member 110 may be shown via α, which may include a range of about 10-70 degrees or more. The substantially planar cable 104 may be inserted into the housing when the first locking member is in the pre-loaded position, and the substantially planar cable 104 may be secured with the housing 102 as the first locking member 110 moves to the closed position.

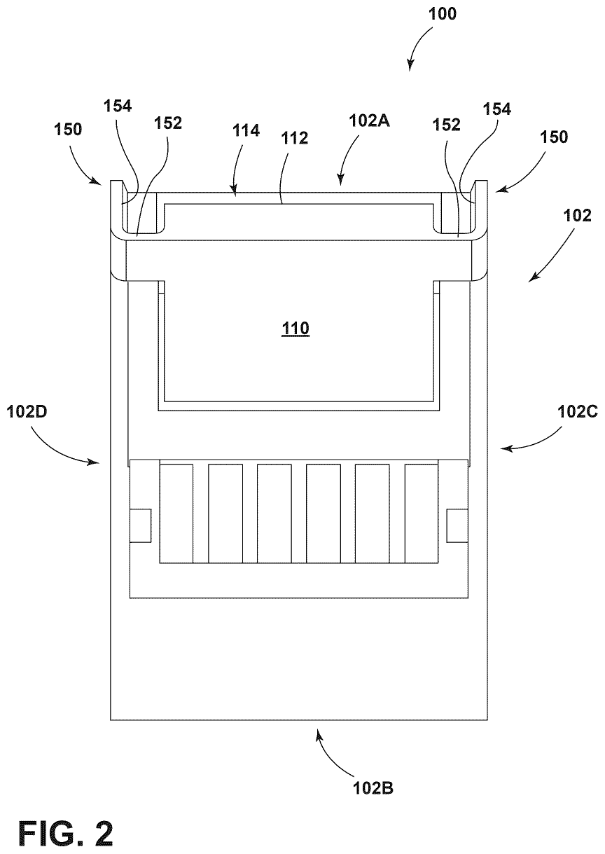

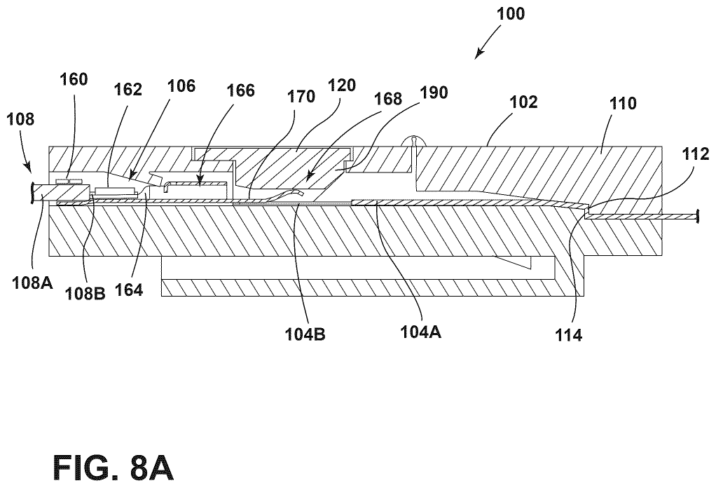

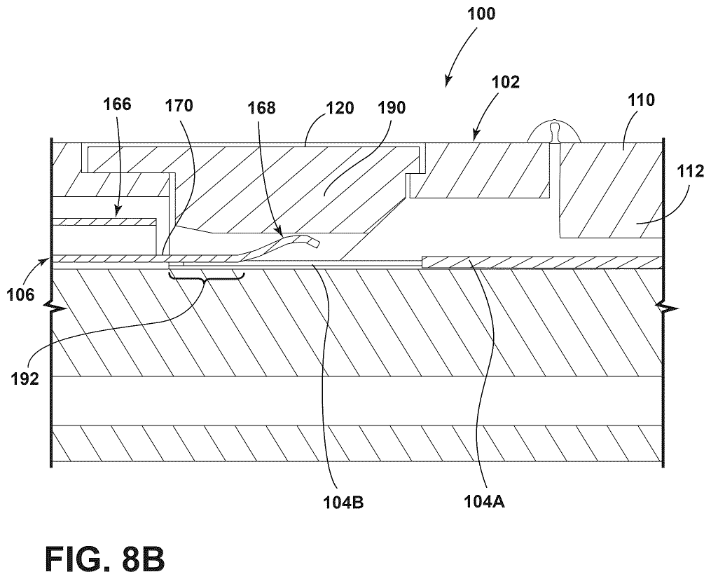

Further, the first locking member 110 may include a contact portion 112 disposed along a bottom surface. The contact portion 112 may be configured to contact a portion of the substantially planar cable 104 as the first locking member 110 rotates from the pre-loaded position to the closed position. For example and without limitation, the substantially planar cable 104 may include an insulative portion 104A and/or a conductive portion 104B. Generally, the contact portion 112 may rotate to contact/engage the insulative portion 104A of the substantially planar cable 104 to substantially limit movement of the substantially planar cable 104 with respect to the housing 102 and/or the one or more terminals 106. The contact portion 112 may be configured to crimp the substantially planar cable 104 with the housing 102 via an edge portion 114 of the housing 102 (as shown in FIGS. 2, 8A).

In embodiments, the housing 102 may include a first aperture 130 disposed on the first side 102A of the housing 102 to at least partially receive a portion of the substantially planar cable 104. The first aperture 130 may be about the same size/shape (e.g., or slightly larger) as the size/shape of the substantially planar cable 104. Additionally, the housing 102 may include a plurality of second apertures 132 disposed on the second side 102B configured to at least partially receive the one or more terminals 106. The plurality of second apertures 132 may include one or more of a variety of shapes, sizes, and/or configurations. For example and without limitation, the second apertures 132 may be rectangular and/or may be about the same size (e.g., or slightly larger) as the one or more terminals 106. In this manner, any shape of second apertures 132 may be used as it may correspond to a complementary shape of the one or more terminals 106 (e.g., in which case a variety of terminal shapes may be used).

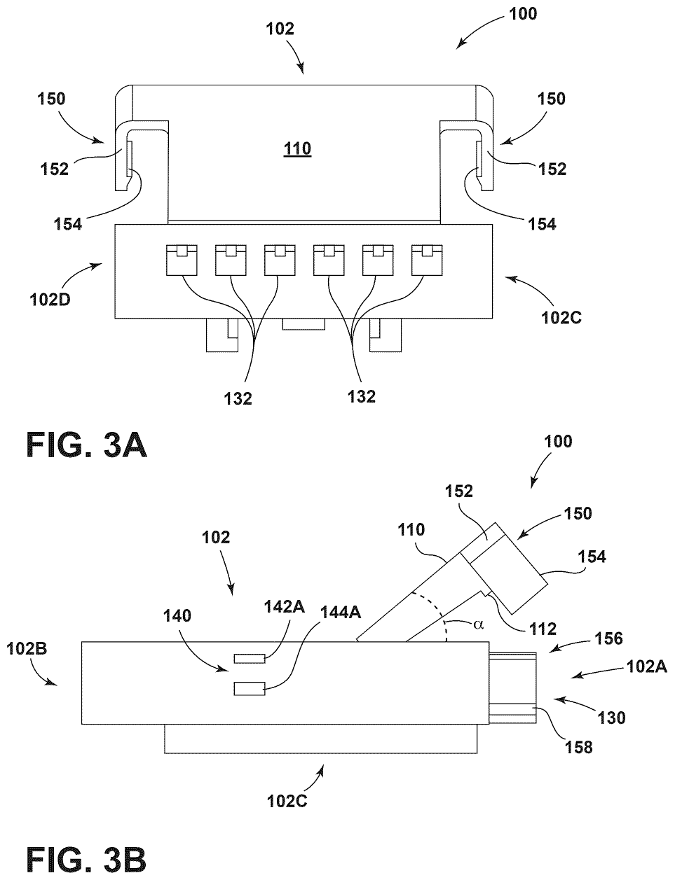

With examples, as illustrated in FIG. 3A, the plurality of second apertures 132 may be disposed/aligned in a linear manner, such as to correspond to a variety of conductors of the substantially planar cable. Further, each of the one or more terminals 106 may be connected with a conductive stranded wire, which may be electrically coupled with one or more conductors of the substantially planar cable 104. In examples, the plurality of second apertures 132 may include about six apertures, but may include more or less apertures depending on the quantity of conductors of the substantially planar cable 104. Additionally, the plurality of second apertures 132 may include varying sizes and/or shapes to accommodate a variety of one or more terminals 106.

In embodiments, such as generally illustrated in FIG. 3B, the housing 102 may include one or more positional apertures 140 disposed on the third side 102C and/or the fourth side 102D. The one or more positional apertures 140 may facilitate a position (e.g., pre-loaded and/or locked positions) of the second locking member 120. The position of the second locking member 120 may be dependent upon which of the one or more positional apertures 140 are at least partially engaged with the second locking member 120. The one or more positional apertures 140 may include a first pair of apertures 142A, 142B and/or a second pair of apertures 144A, 144B. The second locking member 120 may engage with the first pair of apertures 142A, 142B when disposed in the pre-loaded position, and the second locking member 120 may engage with the second pair of apertures 144A, 144B when disposed in the locked position. As can be seen in FIGS. 1, 6A, and 6B, the second locking member 120 may traverse (e.g., in a perpendicular direction with respect to the substantially planar cable 104) between the pre-loaded position and the locked position when securing the one or more terminals 106 with the housing 102 and/or the substantially planar cable 104. The first pair of apertures 142A, 142B may be disposed in an offset manner from the second pair of apertures 144A, 144B, and/or the first pair of apertures 142A, 142B may be disposed vertically above and/or adjacent to the second pair of apertures 144A, 144B.

In embodiments, such as generally illustrated in FIGS. 3A and 3B, the first locking member 110 may include one or more engagement portions 150 to connect and/or disconnect with the housing 102. Further, the engagement portions 150 may extend outwardly from the first locking member 110 via flanges 152, which may extend from one or both of sides 102C, 102D of the housing 102. The one or more engagement portions 150 may include one or more engagement surfaces 154 configured to connect with the housing 102 in a latching manner to limit movement of the substantially planar cable 104. The interaction between the engagement surfaces 154 and the housing 102 may limit rotation of the first locking member 110.

Additionally, the housing 102 may include one or more receiving formations 156 to physically interact with the one or more engagement surfaces 154, thus securing the substantially planar cable 104 with the housing 102. The one or more receiving formations 156 may extend outwardly from the housing 102 and may be generally rectangular in shape (e.g., or any shape that substantially matches a profile shape of the engagement portions 150). The may include one or more channels 158 to at least partially receive and/or engage with the one or more engagement surfaces 154. For example, the one or more engagement surfaces 154 may extend/project from the engagement portion 150 in a wedge-like manner (e.g., a ramped-shape, curved-shape, or the like).

Further, when the first locking member 110 is in the pre-loaded position, the one or more engagement surfaces 154 may not be in contact with the one or more receiving formations 156. As the first locking member 110 rotates into the closed position, the one or more engagement surfaces 154 are at least partially disposed within the one or more channels 158. Retaining the one or more engagement surfaces 154 at least partially within the one or more channels 158 may allow the first locking member 110 to resist transitioning from the closed position to the pre-loaded position unless intentionally actuated.

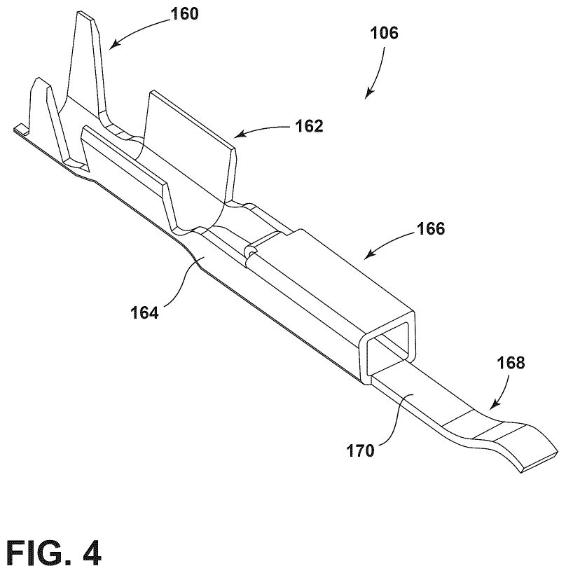

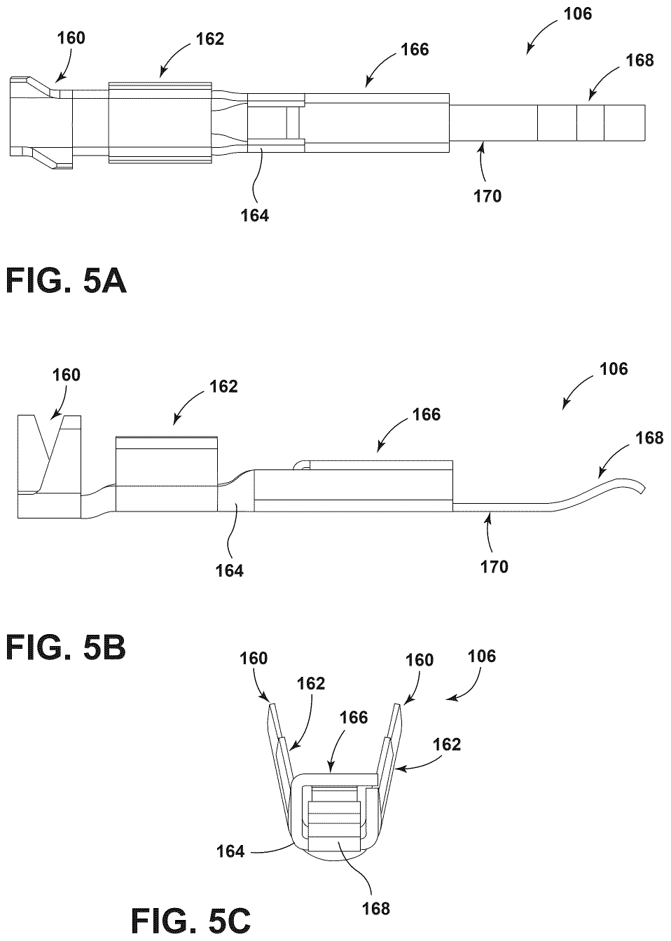

With embodiments, such as generally illustrated in FIGS. 4, 5A, 5B, and 5C, the one or more terminals 106 may include a first pair of wings 160 and/or a second pair of wings 162 that may extend outwardly from a terminal base 164. The one or more terminals 106 may additionally include a transition portion 166 and/or a bent portion 168 extending from the transition portion 166. Further, the transition portion 166 may be disposed between the pairs of wings 160, 162 and the bent portion 168. For example and without limitation, the first pair of wings 160 may connect (e.g., may be crimped) with an insulative portion 108A of the round stranded wires 108, and/or the second pair of wings 162 may connect (e.g., may be crimped) with a conductive portion 108B of the round stranded wires 108.

As seen in FIGS. 6A and 6B, the bent portions 168 may be at least partially received via the plurality of second apertures 132 when electrically connecting the round stranded wires 108 with the housing 102 (e.g., and further, the substantially planar cable 104). The transition portions 166 may include one or more of a variety of shapes, sizes, and/or configurations. For example and without limitation, the shape of the transition portions 166 may correspond with a shape/size of the plurality of second apertures 132. Additionally, the bent portion 168 may extend from the transition portion 166 in one or more of a variety of manners and may include a variety of lengths and shapes (e.g., L-shaped). Generally, the bent portions 168 may be formed such as to extend into the housing 102 of the connector assembly 100 and may be electrically connected with the conductive portion 104B of the substantially planar cable 104. As can be seen in FIGS. 4-5C, a substantially planar and/or linearly extending segment 170 may be disposed between the transition portion 166 and the bent portion 168.

With embodiments, such as generally illustrated in FIGS. 6A and 6B, the first locking member 110 is in the pre-loaded position and the first aperture 130 may be configured to receive at least a portion of the substantially planar cable 104. In this position, the first locking member 110 may not be substantially aligned with the housing 102 (e.g., the first locking member 110 may be disposed at an angle relative to the housing 102). Further, at an opposite end of the housing 102, the second locking member 120 may be disposed in a pre-loaded position where the second locking member 120 is at least partially engaged with the first pair of apertures 142. When the second locking member 120 is in the pre-loaded position, the one or more terminals 106 may be inserted at least partially into the plurality of second apertures 132.

Turning to FIG. 6B, the first locking member 110 may be rotated to the closed position, which may secure the substantially planar cable 104 with the housing 102. The first locking member may be disposed substantially parallel to the housing 102 when in the closed position. At the opposite end of the housing 102, the one or more terminals 106 may be disposed at least partially and/or entirely within the plurality of second apertures 132. The second locking member 120 may traverse (e.g., in a direction substantially perpendicular to the substantially planar cable 104) from the pre-loaded position to the closed position to at least partially limit movement of the one or more terminals 106). When the second locking member 120 is in the closed position, the second locking member 120 may be engaged with the second pair of apertures 144. Further, in the closed position, the second locking member 120 may be disposed substantially parallel to the housing 102 (e.g., a top surface of the second locking member 120 may be flush with an outer surface of the housing 102).

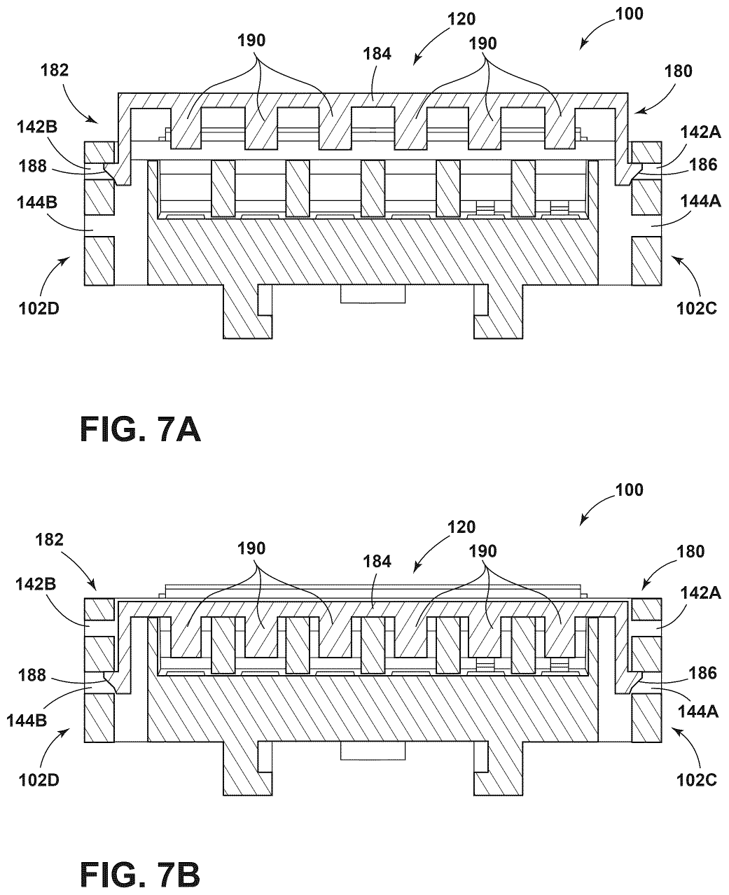

In embodiments, such as generally illustrated in FIGS. 7A and 7B, the second locking member 120 may traverse between a pre-loaded position (e.g., FIG. 7A) and a closed position (e.g., FIG. 7B). Additionally, the second locking member 120 may include a first engagement portion 180 and/or a second engagement portion 182 extending from a base portion 184. The first engagement portion 180 and/or the second engagement portion 182 may extend in a substantially perpendicular direction (e.g., towards the housing 102) with respect to the base portion 184. Further, the first engagement portion 180 and/or the second engagement portion 182 may be configured to at least partially engage/contact the first pair of apertures 142 and/or the second pair of apertures 144 when moving between the pre-loaded position and the closed position. The first engagement portion 180 may be disposed on the third side 102C of the housing 102, and/or the second engagement portion 182 may be disposed on the fourth side 102D of the housing 102. The first engagement portion 180 may include a first engagement surface 186 configured to be disposed at least partially within the first pair of apertures 142 and/or the second pair of apertures 144. The second engagement portion 182 may include a second engagement surface 188 configured to be disposed at least partially within the first pair of apertures 142 and/or the second pair of apertures 144. The first engagement surface 186 and/or the second engagement surface 188 may include one or more of a variety of shapes, sizes, and/or configurations. For example and without limitation, the engagement surfaces 186, 188 may be curved, ramp-shaped, and/or wedge-shaped. The engagement surfaces 186, 188 may be configured to contact and/or traverse along an edge portion (e.g., and between) of the first pair of apertures 142, and/or the second pair of apertures 144. The curved, ramped, and/or wedge shape of the engagement surfaces 186, 188 may permit the engagement portions 180, 182 to traverse from the first pair of apertures 142 to the second pair of apertures 144; which may further cause the base portion 184 and/or the engagement portions 180, 182 to flex, bend, and/or deform in an outwardly direction (e.g., away from the housing 102) as the second locking member 120 moves from the pre-loaded position to the closed position.

With embodiments, the second locking member 120 may include one or more contact portions 190 configured to contact the one or more terminals 106 in securing such with the housing 102. The one or more contact portions 190 may extend from the base portion 14 in a direction substantially towards the housing 102. The one or more contact portions 190 may include one or more of a variety of shapes, sizes, and/or configurations. For example and without limitation, the one or more contact portions 190 may be rectangular shaped and may be about, or less, than a width of the bent portion 168. As the second locking member 120 moves from the pre-loaded position to the closed position, the one or more contact portions 190 may contact the one or more bent portions 168, thus securing the bent portions 168 to the housing 102, and further, to the substantially planar cable 104. The one or more bent portions 168 may be at least partially displaced as the one or more contact portions 190 move towards the one or more terminals 106. For example, the bent portions 168 may be displaced in a direction towards the conductive portion 104B of the substantially planar cable 104 (e.g., to facilitate an electrical connection).

In embodiments, such as generally illustrated in FIGS. 8A and 8B, the first locking member 110 and the second locking member 120 may be disposed in the closed position, thus, limiting movement and electrically connecting the substantially planar cable 104 with the one or more terminals 106. Further, the substantially planar cable 104 may be inserted into the housing 102 prior to inserting the one or more terminals 106. In this manner, the substantially planar cable 104 (e.g., the conductive portion 104B) may be disposed underneath/below the one or more terminals 106. When the second locking member 120 is in the pre-loaded position, the one or more bent portions 168 may be disposed above the conductive portion 104B of the substantially planar cable 104. As the second locking member 120 traverses toward the housing 102 from the pre-loaded position to the closed position, the contact portions 190 may bend/flex the one or more bent portions 168 such that the linearly extending segment 170 and/or the one or more bent portions 168 contact the conductive portion 104B of the substantially planar cable 104. When the first locking member 110 and the second locking member 120 are disposed in the closed position, the one or more terminals 106 may be electrically connected with the substantially planar cable, as illustrated via the connection region 192 in FIG. 8B.

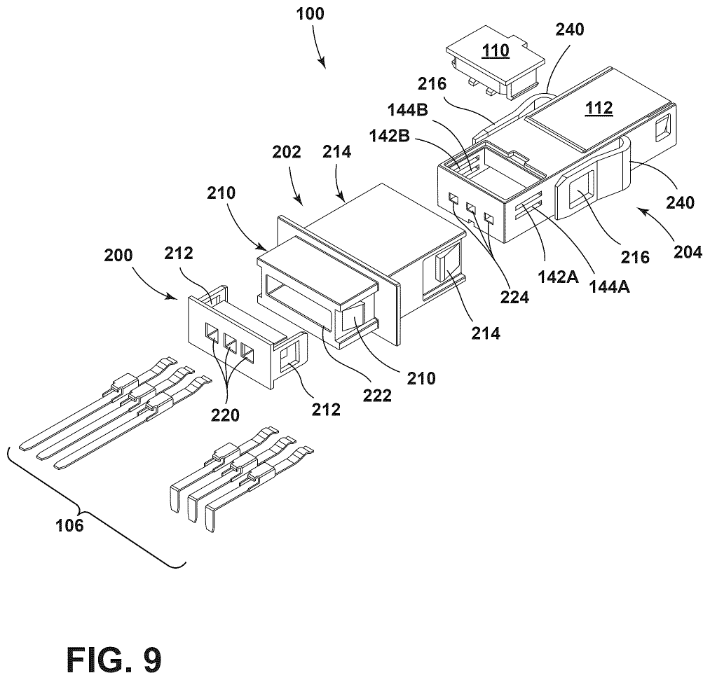

With embodiments, such as generally illustrated in FIGS. 9, 10A, 10B, 11A, 11B, 11C, 12, 13A, 13B, and 13C, the housing 102 may include one or more of a variety of shapes, sizes, and/or configurations. For example and without limitation, the housing 102 may include first housing portion 200, a second housing portion 202, and/or a third housing portion 204. The first housing portion 200 may at least partially engage (e.g., in the lateral direction) with the second housing portion 204, and/or the second housing portion 202 may at least partially engage (e.g., in the lateral direction) with the third housing portion 204. In this manner, the housing 102 may be split into multiple interconnected housing portions 200, 202, 204.

In examples, the first housing portion 200 may be a facia at least partially received by the second housing portion 202. The first housing portion 200 may be connected with the second housing portion 202 via one or more mating protrusions 210 and/or one or more mating apertures 212. For example and without limitation, the one or more mating apertures 212 may receive at least a portion of the one or more mating protrusions 210. The one or more mating apertures 212 may generally include a similar profile shape as the one or more mating protrusions 210. For example and without limitation, the one or more mating apertures 212 may be rectangular and/or square shaped, which may correlate to the ramped/curved surface of the one or more mating protrusions 210. The mating protrusions 210 and/or the mating apertures 212 may be disposed on opposite sides of the first housing portion 200 and/or the second housing portion 202. For example, as shown in FIG. 9, the second housing portion 202 may include the one or more mating protrusions 210 and/or the first housing portion 200 may include the one or more mating apertures 212. In alternative embodiments, positions of the mating protrusions 210 may be interchanged with the positions of the mating apertures 212. In a similar manner, the second housing portion 202 may include a one or more second mating protrusions 214 to engage with the third housing portion 204. Further, the third housing portion 204 may include one or more second mating apertures 216 that engage with the second mating protrusions 214.

With embodiments, the one or more terminals 106 may be inserted at least partially into the first housing portion 200, the second housing portion 202, and/or the third housing portion 204. As can be seen, a variety of apertures may be aligned throughout the housing portions 200, 202, 204 such that the one or more terminals 106 may pass through the housing portions 200, 202, 204 to connect with the substantially planar cable 104 inserted into at least a portion of the second housing member 204 and/or the third housing member 206. Further, the first housing portion 200 may include one or more first apertures 220, the second housing portion 202 may include one or more second apertures 222, and/or the third housing portion 204 may include one or more third apertures 224, which may be substantially aligned with the inserted portions of the substantially planar cable 104 and the one or more terminals 106.

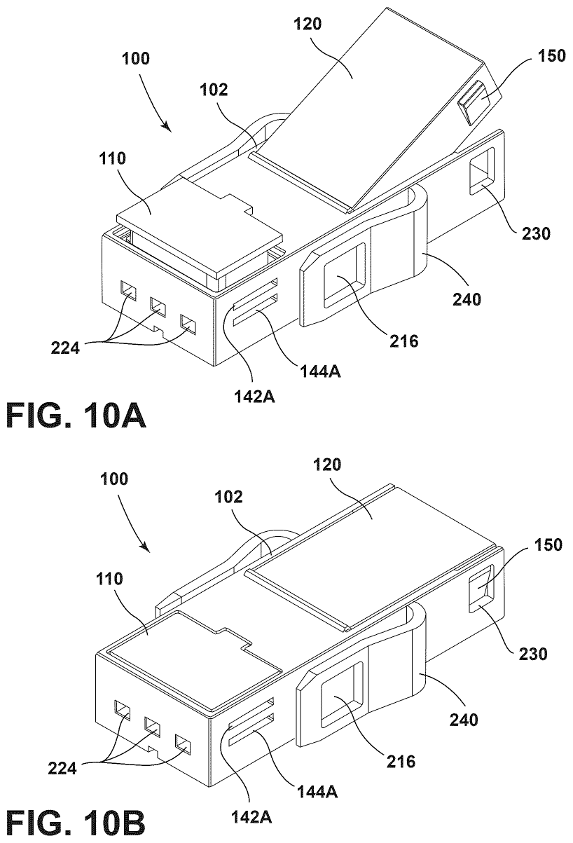

In embodiments, such as generally illustrated in FIGS. 10A and 10B, the connector assembly 100 may include one or more of a variety of shapes, sizes, and/or configurations of the first locking member 110 and/or the second locking member 120. For example and without limitation, the one or more engagement portions 150 may be wedge-shaped and/or ramp-shaped. Further, the engagement portions 150 may facilitate a force-fit connection between the engagement portions 150 and one or more locking apertures 230.

With examples, the first locking member 110 is shown in the pre-loaded state (e.g., see FIG. 10A) where the first locking member 110 may be disposed at least partially above the housing 102 and/or may be engaged with the first pair of apertures 142. The first locking member 110 may not restrict movement of the one or more terminals 106 when disposed in the pre-loaded position, such that the one or more terminals 106 may be inserted into the housing 102. Additionally, the second locking member 120 is shown in the pre-loaded state, where the second locking member 120 may be disposed at an angle relative to the top surface of the housing 102. The second locking member 120 may not restrict movement of the substantially planar cable 104 when disposed in the pre-loaded position, such that the substantially planar cable 104 may be inserted into the housing 102.

Turning next to FIG. 10B, the first locking member 110 may traverse toward the housing 102 (e.g., linearly) to move from the pre-loaded position to the closed position. Further, the second locking member 120 may rotate towards the housing 102 to move from the pre-loaded position to the closed position.

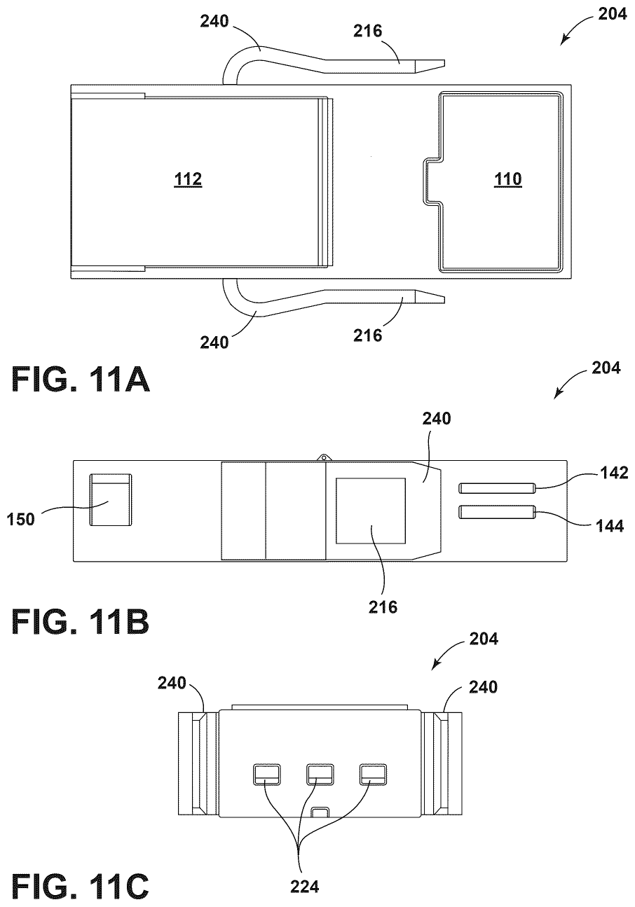

With examples, as generally illustrated in FIGS. 11A, 11B, and 11C, one or more wings 240 may extend from the third housing portion 204. The one or more wings 240 may include one or more of a variety of shapes, sizes, and/or configurations. For example and without limitation, the one or more wings 240 may be generally curved and may extend outwardly from and/or along the third housing portion. The one or more second mating apertures 216 may be disposed on the one or more wings 240, and further, may be disposed at distal ends of the one or more wings 240.

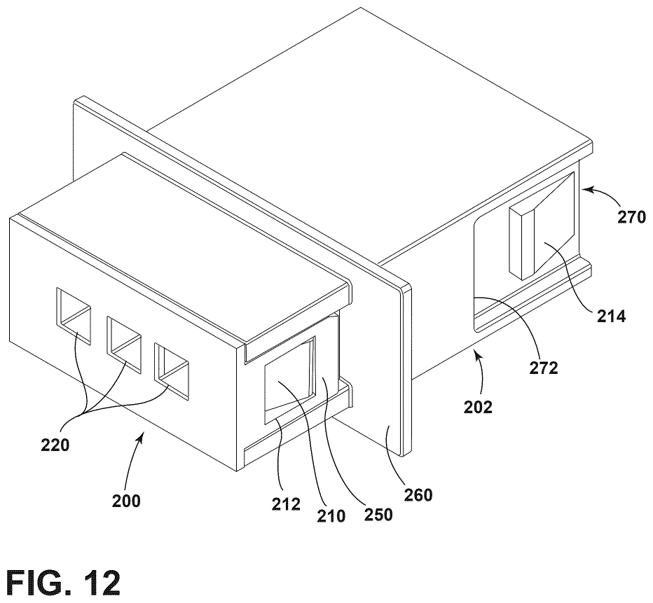

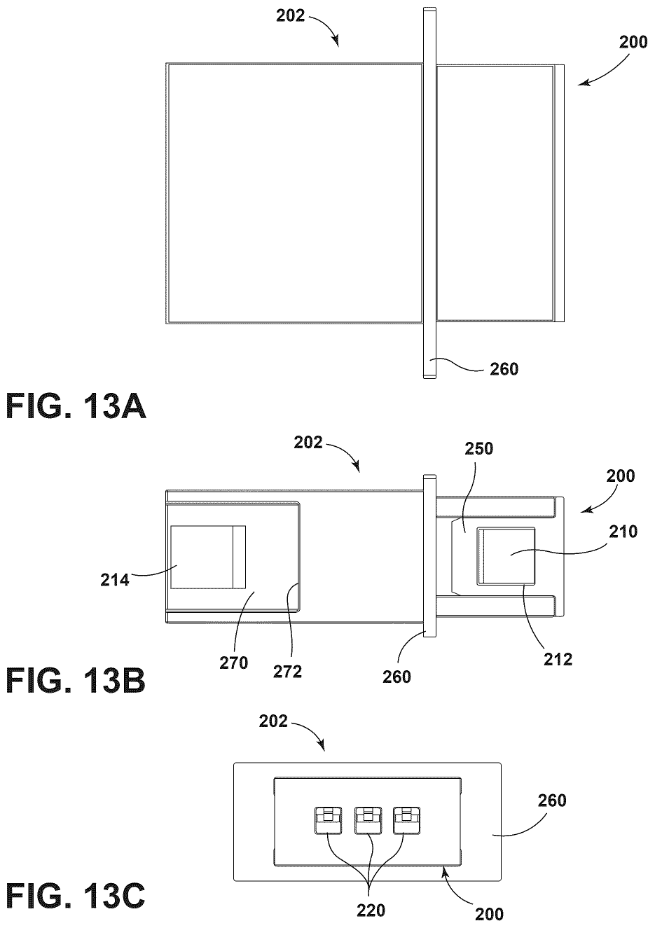

In embodiments, such as generally illustrated in FIGS. 12, 13A, 13B, and 13C, the first housing portion 200 may be configured to connect with the second housing portion 202 in a snap-fit manner. As can be seen, the one or more mating protrusions 210 may be at least partially engaged with the one or more mating apertures 212. The mating apertures 212 may be disposed on one or more mating flanges 250 (e.g., at distal ends thereof) that may extend in a direction towards the second housing portion 202. As the first housing portion 200 connects with the second housing portion 202, the mating flanges 250 may flex (e.g., in a direction outward from the second housing portion 202) while contacting the one or more mating protrusions 210 of the second housing portion 202.

Additionally, the second housing portion 202 may include a shield portion 260 that may extend about a perimeter of the housing 102 (e.g., at a generally middle portion thereof). The shield portion 260 may be one or more of a variety of shapes, sizes, and/or configurations. For example and without limitation, the shield portion 260 may generally be rectangular shaped. Further, the shield portion 260 may provide structural support for the housing portions 200, 202, 204 and/or may provide an end-stop function that may at least partially prevent movement of the housing portions 200, 202, 204 during connection. For example, as can be seen in FIG. 12, the one or more mating flanges 250 may contact the shield portion 260, and therefore, may not traverse through.

With embodiments, such as shown in FIG. 12, the one or more second mating protrusions 214 may be disposed at least partially within one or more ruts 270 of the second housing portion 202. As the third housing portion 204 connects with the second housing portion 202, the one or more wings 240 may be disposed at least partially within the one or more ruts 270. Further, an end 272 of the one or more ruts 270 may physically signal that the connection is complete, once the one or more wings 240 contact the end 272 of the one or more ruts 270.

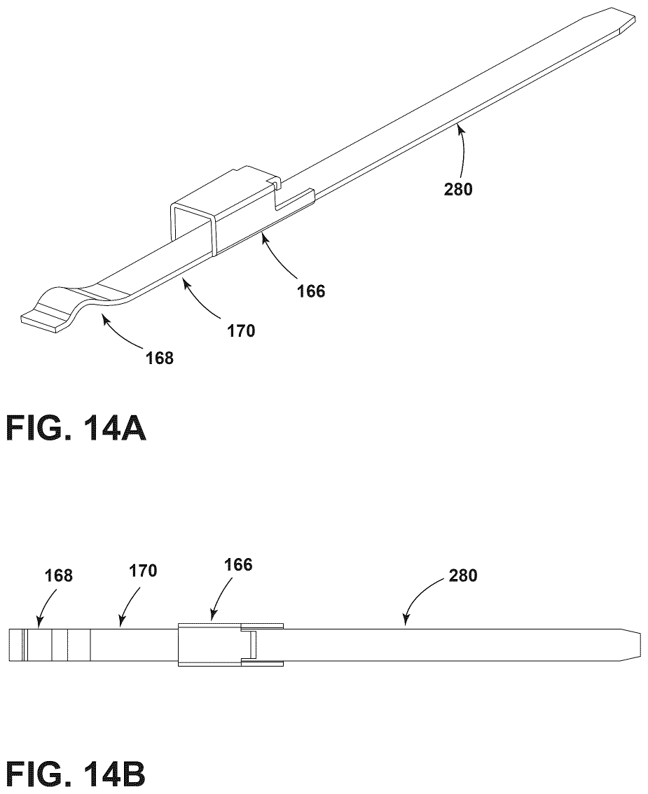

In examples, such as shown in FIG. 14A-17B the one or more terminals 106 may include one or more of a variety of shapes, sizes, and/or configurations. The one or more terminals 106 may include any variety of structure that may be electrically connected with the one or more transition portions 166, bent portions 168, and/or extending segments 170.

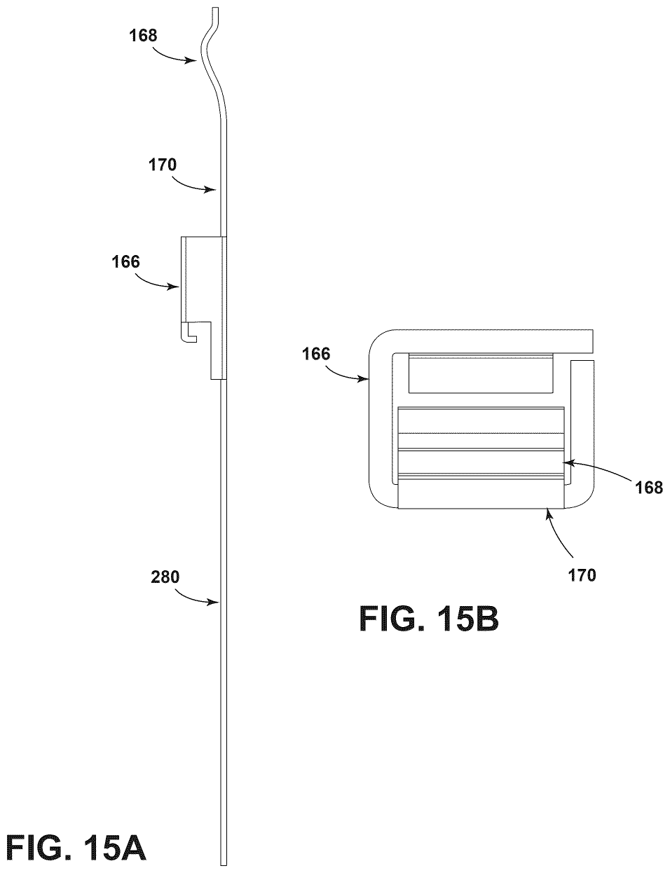

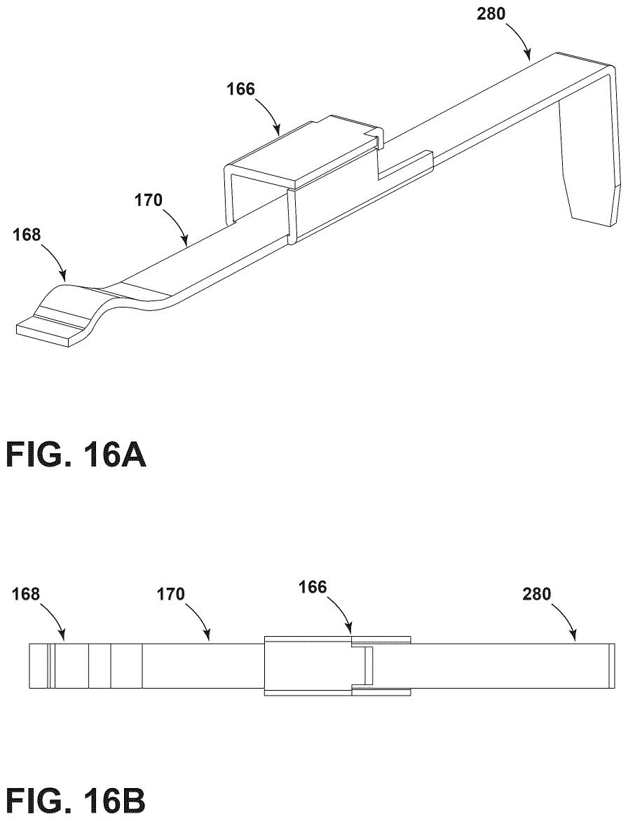

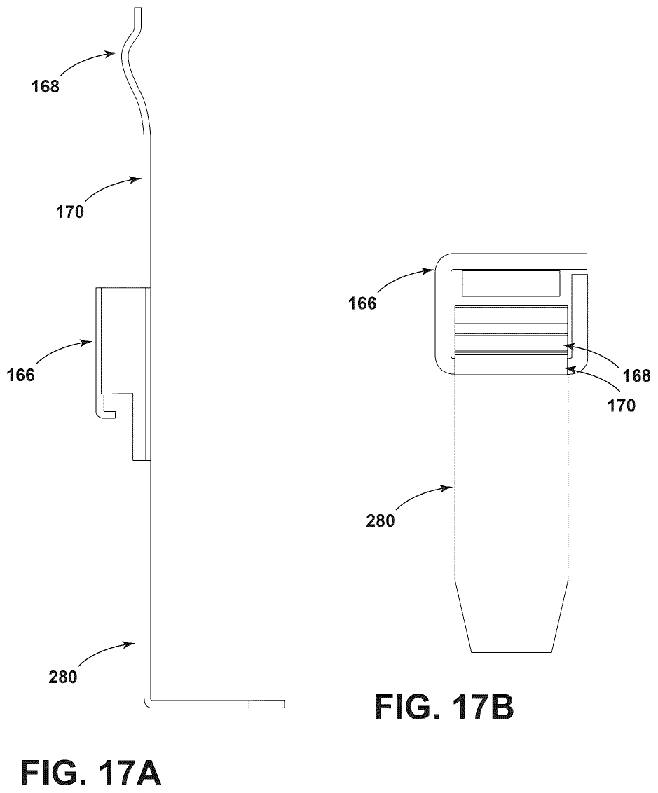

Turning to embodiments of FIGS. 14A, 14B, 15A, and 15B, the one or more terminals 106 may include a connection portion 280, that may extend in a substantially planar/linear manner from the transition portion 166. In additional and/or alternative embodiments, such as in FIGS. 16A, 16B, 17A, and 17B, the connection portion 280 may be substantially L-shaped, bent, and/or rounded. Further, the L-shape, bent, and/or rounded connection portion 280 may facilitate a connection between the one or more terminals 106 and a variety of electrical components/connectors with tucked or partially inaccessible pins/terminals.

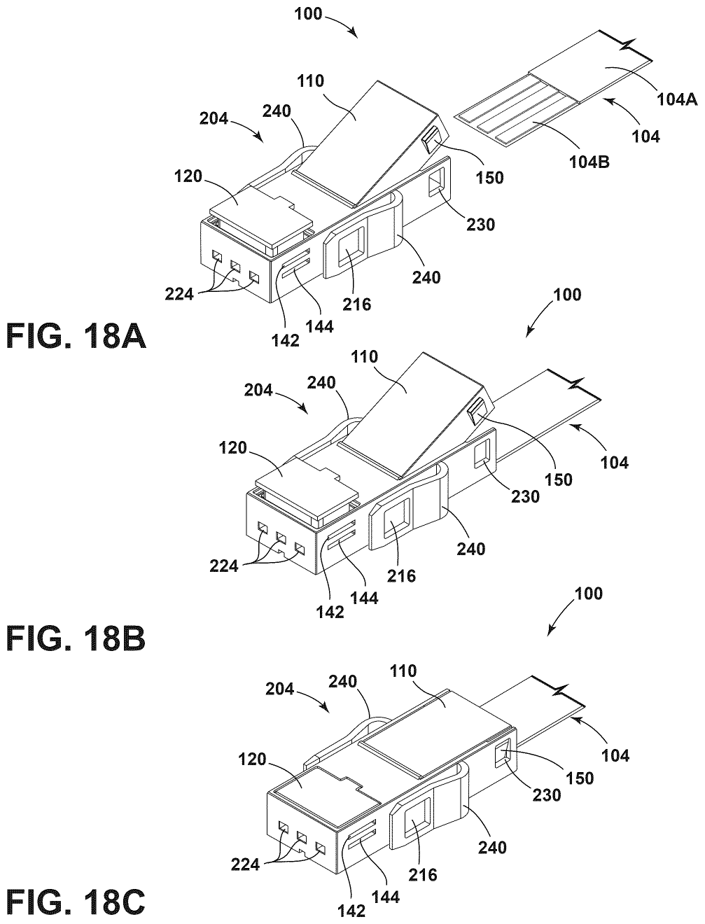

With examples, the third housing portion 204 may at least partially receive the substantially planar cable 104 when the first locking member 110 is in the pre-loaded position as generally illustrated in FIGS. 18A and 18B. Once the substantially planar cable 104 is disposed at least partially within the third housing portion 204, the first locking member 110 may rotate to the closed position, thus securing (e.g., limiting movement in at least one direction) the substantially planar cable 104 with the third housing portion 204. When the first locking member 110 is disposed in the closed position (e.g., as shown in FIG. 18C), the one or more engagement portions 150 may be disposed at least partially within the one or more locking apertures 230. The wedge-shape and/or ramp-shape of the one or more engagement portions 150 may facilitate flexing of the third housing portion 204 as the ramped/wedge surface rotates toward the one or more locking apertures 230. After disposing the first locking member 110 in the closed position, one or more terminals 106 may be inserted into the one or more third apertures 224. Additionally and/or alternately, the third housing portion 204 may be connected with the first housing portion 200 and the second housing portion 202, which may serve as adaptors for connecting a variety of terminals 106 and/or electrical components.

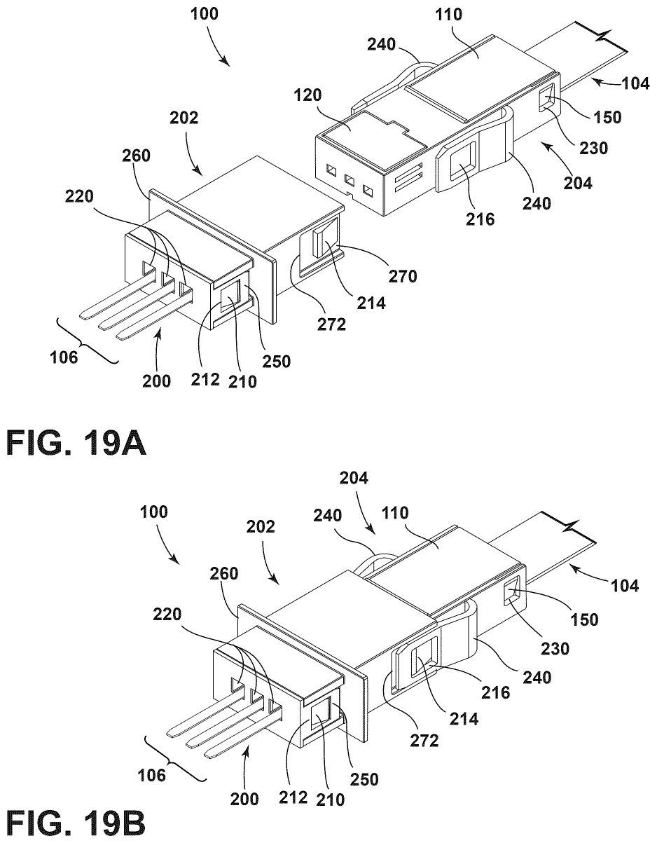

In embodiments, such as generally illustrated in FIGS. 19A and 19B, the third housing portion 204 may connect with the first housing portion 200 and/or the second housing portion 202. Prior to connecting the second housing portion 202 with the third housing portion 204, the first housing portion 200 may connect with the second housing portion 204. In such a configuration, the second housing portion 202 may at least partially cover the second locking member 120 when the second housing portion 202 connects with the third housing portion 204.

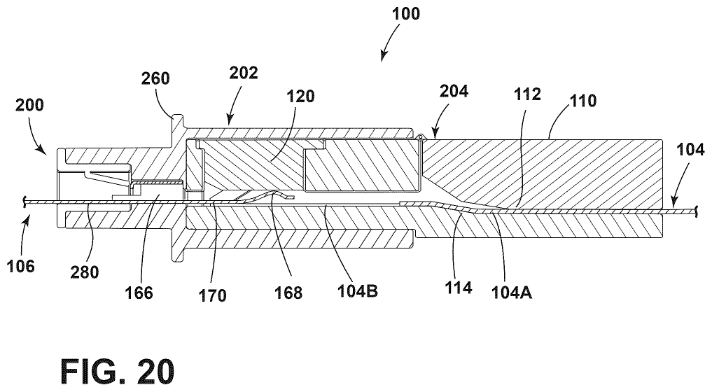

With further embodiments, as shown in FIG. 20, the first locking member 110 may be in contact with the substantially planar cable 104. Moreover, when the first locking member 110 is in the closed position, the contact portion 112 may contact the insulative portion 104A of the substantially planar cable 104. The contact portion 112 may pinch and/or crimp the insulative portion 104A with the edge portion 114. After the substantially planar cable 104 is inserted into the third housing portion 204, the one or more terminals may be inserted into the first housing portion 200 and/or the second housing portion 202. Subsequently, the second housing portion 202 may connect with the third housing portion 204, thus, covering/overlapping the second locking member 120, and maintaining the second locking member 120 in the closed position. The transition between the pre-loaded and the closed position via connection of the second housing portion 202 with the third housing portion 204 may electrically connect the one or more bent portions 168 and/or the one or more linearly extending segments 170 with the insulative portion 104A.

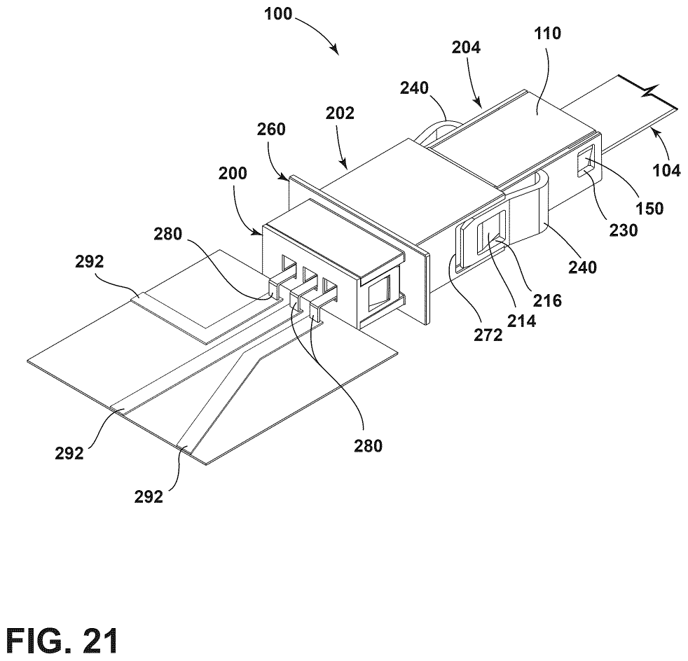

Turning next to FIG. 21, the one or more terminals 106 may connect with a printed circuit board (PCB) 290 or other electrical connection. Further, the connection portions 280 may be electrically connected with the PCB 290 and/or one or more electrical traces 292 thereof. The connection portions 280 may include one or more of a variety of shapes, sizes, and/or configurations to connect with the PCB 290.

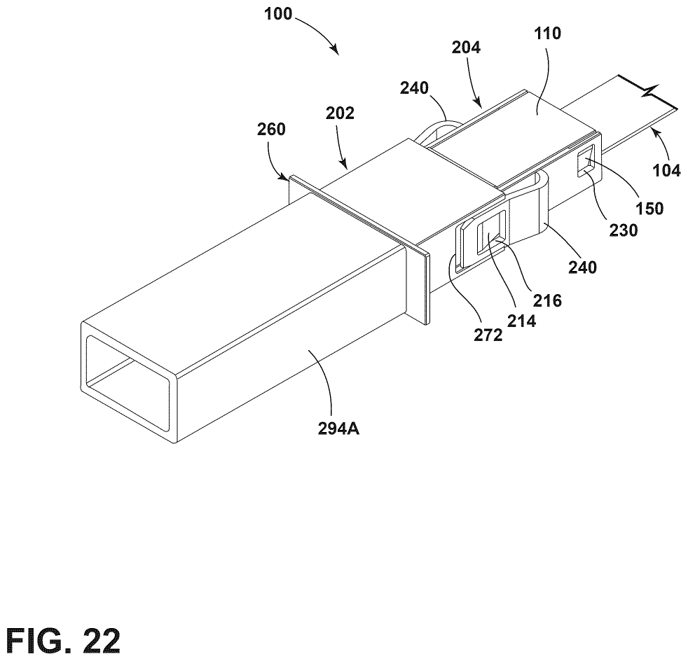

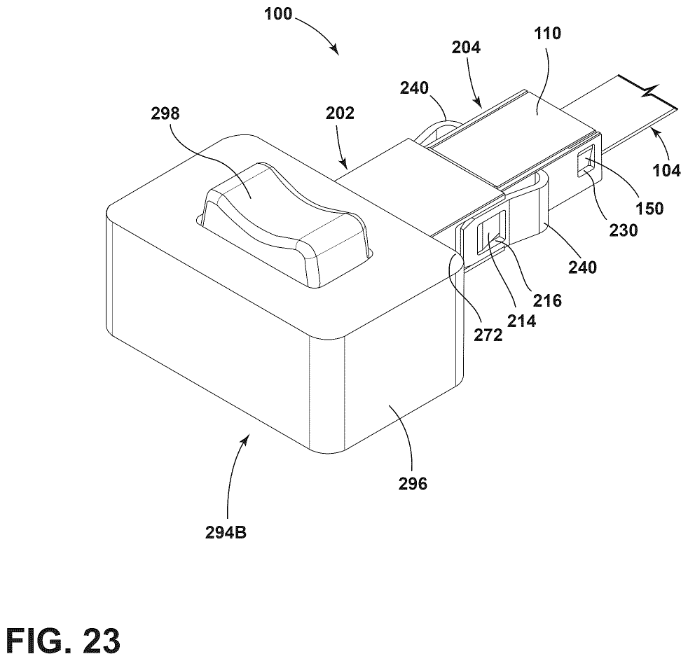

As shown generally by FIG. 22, the first housing portion 200 may be in the form of a sleeve/sheath/tube 294A. The first housing portion 200 may extend from the second housing portion 202 to connect with a variety of conductive and non-conductive components. Turing next to FIG. 23, the first housing portion 200 may alternately be formed as a switch 294B, having a switch housing 296 and/or a mechanical switch 298, that may connect with the second housing portion 202.

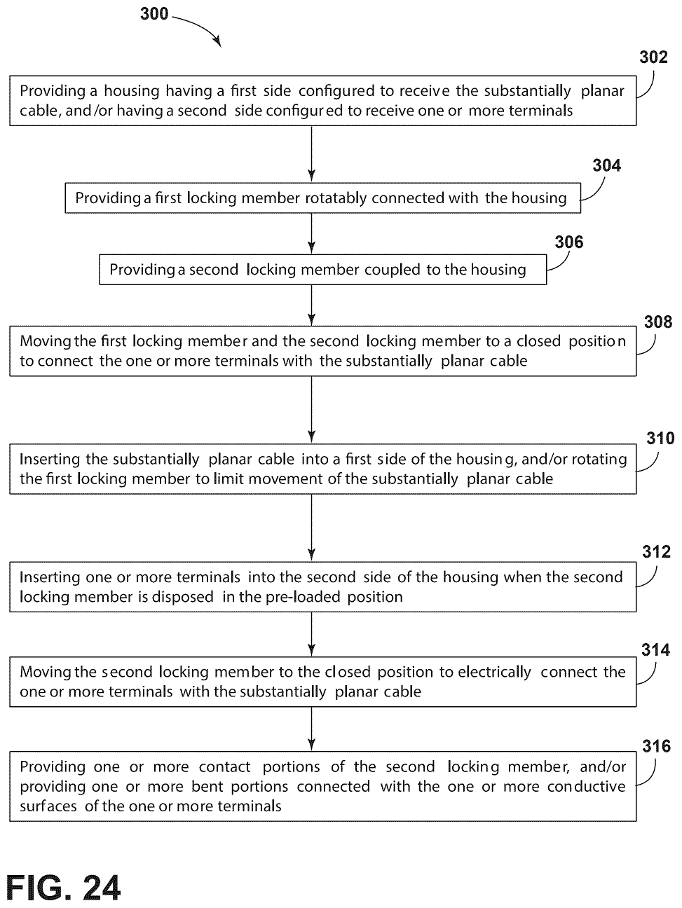

With embodiments, such as generally illustrated in FIG. 24, a method 300 of coupling the substantially planar cable 104 with the one or more terminals 106 may comprise providing a housing 102 having a first side 102A configured to receive the substantially planar cable 104, and/or having a second side 102B configured to receive one or more terminals 106 (block 302). Additionally, the method 300 may include providing a first locking member 110 rotatably connected with the housing 102 (block 304), and further, the method 300 may include providing a second locking member 120 coupled to the housing 102 (block 306). Further, the method 300 may include moving the first locking member 110 and the second locking member 120 to a closed position to connect the one or more terminals 106 with the substantially planar cable 104 (step 308).

In some configurations, the method 300 of coupling a substantially planar cable 104 with the one or more terminals 106 may comprise inserting the substantially planar cable 104 into a first side 102A of the housing 102, and/or rotating the first locking member 110 to limit movement of the substantially planar cable 104 (block 310). The method 300 may further include inserting the one or more terminals 106 into the second side 102B of the housing 102 when the second locking member 120 is disposed in the pre-loaded position (e.g., a first position) (block 312).

With further embodiments, the method 300 of coupling the substantially planar cable 104 with the one or more terminals 106 may comprise moving the second locking member 120 to the closed position to electrically connect the one or more terminals 106 with the substantially planar cable 104 (block 314). Further, movement of the one or more terminals 106 may be limited in at least one direction when the second locking member 120 is in the closed position. In additional embodiments, the method 300 may comprise providing one or more contact portions of the second locking member 120, and/or providing one or more bent portions 168 connected with the one or more conductive surfaces of the one or more terminals 106 (block 316).

The disclosure includes, without limitation, the following embodiments:

1. A connector for electrically connecting a substantially planar cable and one or more terminals, the connector comprising: a housing including: a first end adapted to receive said substantially planar cable; a second end adapted to receive said one or more terminals; a first locking member connected to the housing, the first locking member movable from a pre-loaded position to a closed position configured to secure said substantially planar cable; a second locking member connectable to the housing in a direction substantially perpendicular to said substantially planar cable, wherein, in a connected position, the second locking member electrically connects said one or more terminals with said substantially planar cable.

2. The connector assembly according to any of the preceding embodiments, wherein the first locking member includes a first contact portion configured to rotate into contact with an insulated portion of said substantially planar cable.

3. The connector assembly according to any of the preceding embodiments, wherein the first contact portion connects said insulated portion of said substantially planar cable to an interior surface of the housing.

4. The connector assembly according to any of the preceding embodiments, wherein the first contact portion crimps said insulated portion of said substantially planar cable with the housing via an edge portion.

5. The connector assembly according to any of the preceding embodiments, wherein the second locking member includes one or more second contact portions adapted to contact one or more bent portions of said one or more terminals to electrically couple said one or more terminals with said substantially planar cable.

6. The connector assembly according to any of the preceding embodiments, wherein said one or more terminals include one or more conductive surfaces connected to the one or more bent portions such that as the second locking member contacts the one or more bent portions, the one or more conductive surfaces electrically connect with a conductive portion of said substantially planar cable.

7. The connector assembly according to any of the preceding embodiments, wherein the second locking member is disposed in at least one of a first position and a second position; the one or more bent portions are not in contact with the one or more conductive surfaces when the second locking member is in the first position.

8. The connector assembly according to any of the preceding embodiments, wherein the one or more bent portions are in electrical connection with the one or more conductive portions when the second locking member is in the second position.

9. The connector assembly according to any of the preceding embodiments, wherein the second locking member connects to the housing via a first engagement portion and a second engagement portion; the first engagement portion and the second engagement portion are configured to at least partially engage with a first aperture and a second aperture of the housing when disposed in a first position to limit movement of the second locking member in a direction away from the housing.

10. The connector assembly according to any of the preceding embodiments, wherein the first engagement portion and the second engagement portion are protrusions configured to be at least partially disposed within the first aperture and the second aperture when the second locking member is in the first position; and the first engagement portion and the second engagement portion are disposed on opposite sides of the second locking member; and the first aperture and the second aperture are disposed on opposite sides of the housing.

11. The connector assembly according to any of the preceding embodiments, wherein the housing includes a third aperture and a fourth aperture; the third aperture and the fourth aperture are disposed vertically adjacent to the first aperture and the second aperture, respectfully; and the second locking member at least partially engages the third aperture and the fourth aperture when the second locking member is in a second position.

12. The connector assembly according to any of the preceding embodiments, wherein movement of the second locking member is limited in a direction away from the housing when the second locking member is in the first position and the second position.

13. The connector assembly according to any of the preceding embodiments, wherein the first position is a pre-load position where movement of said one or more terminals is not limited by the second locking member.

14. The connector assembly according to any of the preceding embodiments, wherein the second position is a locked position where movement of said one or more terminals and the second locking member is limited in all directions.

15. The connector assembly according to any of the preceding embodiments, wherein said substantially planar cable is a Flat Flexible Cable (FFC).

16. A method of coupling a substantially planar cable with one or more terminals comprises: providing a housing having a first end configured to receive said substantially planar cable and a second end configured to receive said one or more terminals; providing a first locking member rotatably coupled to the housing; providing a second locking member coupled to the housing; wherein movement of the first locking member and the second locking member electrically connect said one or more terminals with said substantially planar cable.

17. The method according to any of the preceding embodiments, further comprising: inserting said substantially planar cable into the first end of the housing; and rotating the first locking member to limit movement of said substantially planar cable.

18. The method according to any of the preceding embodiments, further comprising: inserting said one or more terminals into the second end of the housing when the second locking member is disposed in a first position.

19. The method according to any of the preceding embodiments, further comprising: moving the second locking member to a second position to electrically connect said one or more terminals with said substantially planar cable; wherein movement of said one or more terminals is limited in at least one direction when the second locking member is in the second position.

20. The method according to any of the preceding embodiments, further comprising: providing one or more contact portions of the second locking member; providing one or more bent portions connected with one or more conductive surfaces of said one or more terminals; moving the one or more bent portions via contact from the second locking member such that the one or more conductive surfaces of said one or more terminals are in electrical contact with said substantially planar cable.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g. ” and “such as” in the specification are to be construed broadly and are used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A connector for electrically connecting a substantially planar cable and one or more terminals, the connector comprising:
a housing including:
a first end adapted to receive said substantially planar cable;
a second end adapted to receive said one or more terminals;
a first locking member connected to the housing, the first locking member movable from a pre-loaded position to a closed position configured to secure said substantially planar cable;
a second locking member connectable to the housing in a direction substantially perpendicular to said substantially planar cable,
wherein, in a connected position, the second locking member electrically connects said one or more terminals with said substantially planar cable.

2. The connector of claim 1, wherein the first locking member includes a first contact portion configured to rotate into contact with an insulated portion of said substantially planar cable.

3. The connector of claim 2, wherein the first contact portion connects said insulated portion of said substantially planar cable to an interior surface of the housing.

4. The connector of claim 3, wherein the first contact portion crimps said insulated portion of said substantially planar cable with the housing via an edge portion.

5. The connector of claim 1, wherein the second locking member includes one or more second contact portions adapted to contact one or more bent portions of said one or more terminals to electrically couple said one or more terminals with said substantially planar cable.

6. The connector of claim 5, wherein said one or more terminals include one or more conductive surfaces connected to the one or more bent portions such that as the second locking member contacts the one or more bent portions, the one or more conductive surfaces electrically connect with a conductive portion of said substantially planar cable.

7. The connector of claim 6, wherein the second locking member is disposed in at least one of a first position and a second position; the one or more bent portions are not in contact with the one or more conductive surfaces when the second locking member is in the first position.

8. The connector of claim 7, wherein the one or more bent portions are in electrical connection with the one or more conductive portions when the second locking member is in the second position.

9. The connector of claim 5, wherein the second locking member connects to the housing via a first engagement portion and a second engagement portion; the first engagement portion and the second engagement portion are configured to at least partially engage with a first aperture and a second aperture of the housing when disposed in a first position to limit movement of the second locking member in a direction away from the housing.

10. The connector of claim 9, wherein the first engagement portion and the second engagement portion are protrusions configured to be at least partially disposed within the first aperture and the second aperture when the second locking member is in the first position; and the first engagement portion and the second engagement portion are disposed on opposite sides of the second locking member; and the first aperture and the second aperture are disposed on opposite sides of the housing.

11. The connector of claim 10, wherein the housing includes a third aperture and a fourth aperture; the third aperture and the fourth aperture are disposed vertically adjacent to the first aperture and the second aperture, respectfully; and the second locking member at least partially engages the third aperture and the fourth aperture when the second locking member is in a second position.

12. The connector of claim 11, wherein movement of the second locking member is limited in a direction away from the housing when the second locking member is in the first position and the second position.

13. The connector of claim 11, wherein the first position is a pre-load position where movement of said one or more terminals is not limited by the second locking member.

14. The connector of claim 13, wherein the second position is a locked position where movement of said one or more terminals and the second locking member is limited in all directions.

15. The connector of claim 1, wherein said substantially planar cable is a Flat Flexible Cable (FFC).

16. A method of coupling a substantially planar cable with one or more terminals comprises:
providing a housing having a first end configured to receive said substantially planar cable and a second end configured to receive said one or more terminals;
providing a first locking member rotatably coupled to the housing;
providing a second locking member coupled to the housing;
wherein movement of the first locking member and the second locking member electrically connect said one or more terminals with said substantially planar cable.

17. The method of claim 16, further comprising:
inserting said substantially planar cable into the first end of the housing; and
rotating the first locking member to limit movement of said substantially planar cable.

18. The method of claim 17, further comprising:
inserting said one or more terminals into the second end of the housing when the second locking member is disposed in a first position.

19. The method of claim 18, further comprising:
moving the second locking member to a second position to electrically connect said one or more terminals with said substantially planar cable; wherein movement of said one or more terminals is limited in at least one direction when the second locking member is in the second position.

20. The method of claim 19, further comprising:
providing one or more contact portions of the second locking member;
providing one or more bent portions connected with one or more conductive surfaces of said one or more terminals;
moving the one or more bent portions via contact from the second locking member such that the one or more conductive surfaces of said one or more terminals are in electrical contact with said substantially planar cable.
